(19) United States
(12) Patent Application Publication
(10) Pub. No.: US 2026/0074786 A1
(43) Pub. Date: Mar. 12, 2026

(54) PREVENTIVE MAINTENANCE METHOD FOR OPTICAL MODULE AND PREVENTIVE MAINTENANCE APPARATUS FOR OPTICAL MODULE

(71) Applicant: Hitachi Vantara, Ltd., Yokohama-shi (JP)

(72) Inventors: Yuta IKEDA, Tokyo (JP); Hiroshi SHINODA, Tokyo (JP)

(21) Appl. No.: 19/074,151

(22) Filed: Mar. 7, 2025

(30) Foreign Application Priority Data
Sep. 11, 2024 (JP) 2024-157838

(51) Int. Cl. H04B 10/079; H04B 10/564

(52) U.S. Cl. CPC H04B 10/07955; H04B 10/07953; H04B 10/564

(57) ABSTRACT

A preventive maintenance method for an optical module, for preventing degradation of an optical module and performing maintenance of the optical module, in which the optical module includes an internal measuring instrument that measures physical quantities including optical transmission power and a bias current and an internal memory in which the measured physical quantities are recorded, includes reporting a degradation state of a light emitting element of the optical module by a control unit using a diagnosis result obtained by a signal quality degradation determiner. The control unit includes a correlation coefficient calculator that calculates, from the optical transmission power and the bias current recorded in the internal memory of the optical module, a correlation coefficient for converting the optical transmission power to a signal quality, and a signal quality calculator that calculates a signal quality with use of a correlation expression.

### BACKGROUND OF THE INVENTION

### 1. Field of the Invention

The present invention relates to a preventive maintenance method for an optical module and a preventive maintenance apparatus for an optical module.

### 2. Description of the Related Art

Optical modules are widely used as standardized interfaces for connecting, for example, storage apparatuses and storage network equipment (switches), which are main constitutional apparatuses of a data center, and have supported the core of communication networks.

JP-2015-26955-A discloses a control method of giving cumulative points according to an operating time of an optical module, an environment temperature, optical transmission power, and a bias current value of a semiconductor laser and estimating the degree of degradation of the optical module.

### SUMMARY OF THE INVENTION

However, it has been common to use a bit error rate (BER), which is an indicator of signal quality, to determine the presence/absence of an abnormality in signals in a communication network, but it is difficult to measure a BER with a function of a single optical module. Hence, it has been difficult to clarify an effect of the degree of degradation of an optical module on a BER.

In preventive maintenance means implemented according to the degree of degradation of an optical module, when a determination on the degree of degradation of an optical module is made based on an operating time of the optical module, an environment temperature, optical transmission power, and a bias current value of a semiconductor laser, a BER is not taken into consideration. Thus, replacement of an optical module at a proper timing with an entire communication network taken into consideration is not promoted. This causes a problem of an increase in the replacement cost due to early replacement of optical modules.

JP-2015-26955-A discloses a control method in which the degree of degradation of an optical module is estimated according to cumulative points given according to an operating time of an optical module, an environment temperature, optical transmission power, and a bias current value of a semiconductor laser. However, JP-2015-26955-A includes no description in which a BER is taken into consideration.

The present invention has been made in view of the above matters, and an object thereof is to realize a preventive maintenance method for an optical module and a preventive maintenance apparatus for an optical module, by which a BER can be estimated with high accuracy according to the degradation state of an optical module and replacement of an optical module at a proper timing can be promoted.

Moreover, the above object and any other objects of the present invention and the novel features of the present invention will be apparent from the present description and the accompanying drawings.

A preventive maintenance method for an optical module according to the present invention is for preventing degradation of an optical module and performing maintenance of the optical module.

In the preventive maintenance method for an optical module according to the present invention, the optical module includes an internal measuring instrument that measures physical quantities including optical transmission power and a bias current and an internal memory in which the measured physical quantities are recorded. The preventive maintenance method includes reporting a degradation state of a light emitting element of the optical module by a control unit using a diagnosis result obtained by a signal quality degradation determiner. The control unit includes a correlation coefficient calculator that calculates, from the optical transmission power and the bias current recorded in the internal memory of the optical module, a correlation coefficient for converting the optical transmission power to a signal quality, a signal quality calculator that calculates a signal quality with use of a correlation expression including the optical transmission power and the correlation coefficient, and the signal quality degradation determiner that diagnoses degradation in the signal quality by comparing the signal quality and a signal quality degradation identification value.

A preventive maintenance apparatus for an optical module according to the present invention is for preventing degradation of an optical module and performing maintenance of the optical module.

The preventive maintenance apparatus for an optical module according to the present invention is targeted for an optical module including an internal measuring instrument that measures physical quantities including optical transmission power and a bias current and an internal memory in which the measured physical quantities are recorded. The preventive maintenance apparatus includes a correlation coefficient calculator that calculates, from the optical transmission power and the bias current recorded in the internal memory of the optical module, a correlation coefficient for converting the optical transmission power to a signal quality, a signal quality calculator that calculates a signal quality with use of a correlation expression including the optical transmission power and the correlation coefficient, and a signal quality degradation determiner that diagnoses degradation in the signal quality by comparing the signal quality and a signal quality degradation identification value. The preventive maintenance apparatus reports a degradation state of a light emitting element of the optical module with use of a diagnosis result obtained by the signal quality degradation determiner.

According to the abovementioned present invention, a BER can be estimated with high accuracy according to the degradation state of an optical module, and replacement of an optical module at a proper timing can be promoted.

It is to be noted that problems, configurations, and effects other than those mentioned above will become apparent from an explanation of embodiments below.

### BRIEF DESCRIPTION OF THE DRAWINGS

FIG. 1 is a configuration diagram of preventive maintenance means for an optical module according to a first embodiment;

FIG. 2 is a schematic configuration diagram (block diagram) of the optical module in FIG. 1;

FIG. 3 is a flowchart of the preventive maintenance means for the optical module according to the first embodiment;

FIGS. 4A and 4B are diagrams each indicating a method of calculating a correlation coefficient at a signal quality converter in FIG. 1; and

FIG. 5 is a flowchart of preventive maintenance means for an optical module according to a second embodiment.

### DESCRIPTION OF THE PREFERRED EMBODIMENTS

In the following embodiments, the invention will be described in a plurality of separate sections or embodiments if necessary for the sake of convenience. However, these sections or embodiments related to each other unless otherwise stated, and one of these sections or embodiments is a modification, details, or a supplementary explanation of another one.

In addition, in the following embodiments, when reference is made to the number of elements (including the number of pieces, a numerical value, an amount, a range, and the like), the number of the elements is not limited to a specific number unless otherwise stated or except a case where the number is apparently limited to the specific number in principle. A number that is greater or less than the specific number can be adopted.

Further, in the following embodiments, it goes without saying that the constituent elements (including element steps and the like) are not necessarily indispensable unless otherwise stated or except a case where the elements are apparently indispensable in principle. Similarly, in the following embodiments, when reference is made to the shapes of constituent elements, the positional relation therebetween, and the like, the substantially approximate or similar shapes or the like are included therein unless otherwise stated or except a case where it is possible that they are obviously excluded in principle. The same applies to the abovementioned numerical value and the range.

In addition, throughout all the drawings for illustrating the following embodiments, components that have the same function are in principle denoted by the same reference symbols, and a repetitive explanation thereof will be omitted.

A preventive maintenance method for an optical module according to the present invention is for preventing degradation of an optical module and performing maintenance of the optical module.

In the preventive maintenance method for an optical module according to the present invention, the optical module includes an internal measuring instrument that measures physical quantities including optical transmission power and a bias current and an internal memory in which the measured physical quantities are recorded.

The preventive maintenance method for an optical module according to the present invention includes reporting a degradation state of a light emitting element of the optical module by a control unit using a diagnosis result obtained by a signal quality degradation determiner, and the control unit includes a correlation coefficient calculator that calculates, from the optical transmission power and the bias current recorded in the internal memory of the optical module, a correlation coefficient for converting the optical transmission power to a signal quality, a signal quality calculator that calculates a signal quality with use of a correlation expression including the optical transmission power and the correlation coefficient, and the signal quality degradation determiner that diagnoses degradation in the signal quality by comparing the signal quality and a signal quality degradation identification value.

A preventive maintenance apparatus for an optical module according to the present invention is for preventing degradation of an optical module and performing maintenance of the optical module.

The preventive maintenance apparatus for an optical module according to the present invention is targeted for an optical module including an internal measuring instrument that measures physical quantities including optical transmission power and a bias current and an internal memory in which the measured physical quantities are recorded.

The preventive maintenance apparatus for an optical module according to the present invention includes a correlation coefficient calculator that calculates, from the optical transmission power and the bias current recorded in the internal memory of the optical module, a correlation coefficient for converting the optical transmission power to a signal quality, a signal quality calculator that calculates a signal quality with use of a correlation expression including the optical transmission power and the correlation coefficient, and a signal quality degradation determiner that diagnoses degradation in the signal quality by comparing the signal quality and the signal quality degradation identification value. The preventive maintenance apparatus is configured to report the degradation state of a light emitting element of the optical module with use of a diagnosis result obtained by the signal quality degradation determiner.

The abovementioned preventive maintenance method for an optical module according to the present invention and the abovementioned preventive maintenance apparatus for an optical module according to the present invention are targeted for an optical module including an internal measuring instrument that measures physical quantities including optical transmission power and a bias current and an internal memory in which the measured physical quantities are recorded.

For example, the optical module having this configuration is installed in a storage apparatus or storage network equipment in a data center or the like, as previously explained, and is connected to an apparatus or equipment via a wired interface.

It is to be noted that the optical module can be configured to further measure physical quantities (optical reception power, module environment temperature, module power source voltage, etc.) other than optical transmission power and a bias current, and record the measured physical quantities in the internal memory, which will be described in an embodiment later.

In the abovementioned preventive maintenance method for an optical module according to the present invention and the abovementioned preventive maintenance apparatus for an optical module according to the present invention, the control unit or a control device including at least the correlation coefficient calculator, the signal quality calculator, and the signal quality degradation determiner is used.

The correlation coefficient calculator calculates, from the optical transmission power and the bias current recorded in the internal memory of the optical module, a correlation coefficient for converting the optical transmission power to a signal quality.

The signal quality calculator calculates a signal quality with use of a correlation expression including the optical transmission power and the correlation coefficient calculated by the correlation coefficient calculator.

The signal quality degradation determiner diagnoses degradation in the signal quality by comparing the signal quality and a signal quality degradation identification value.

In the preventive maintenance method for an optical module according to the present invention and the preventive maintenance apparatus for an optical module according to the present invention, the degradation state of a light emitting element of the optical module is reported with use of a diagnosis result obtained by the signal quality degradation determiner.

The control unit or the control device in the preventive maintenance method for an optical module according to the present invention and the preventive maintenance apparatus for an optical module according to the present invention can be formed of any hardware processor such as a central processing unit (CPU).

As the hardware processor such as a CPU, a hardware processor that is built in a storage apparatus or storage network equipment to which an optical module is connected can be used.

With the preventive maintenance method for an optical module according to the present invention and the preventive maintenance apparatus for an optical module according to the present invention, a signal quality is calculated with use of the correlation expression including the optical transmission power and the correlation coefficient, degradation in the signal quality is diagnosed by comparison of the signal quality and the signal quality degradation identification value, and the degradation state of a light emitting element of the optical module is reported with use of the diagnosis result.

Accordingly, a BER can be estimated with high accuracy according to the degradation state of the optical module, and replacement of the optical module at a proper timing can be promoted.

### EMBODIMENTS

Next, specific embodiments of the present invention will be explained in detail on the basis of the drawings.

### First Embodiment

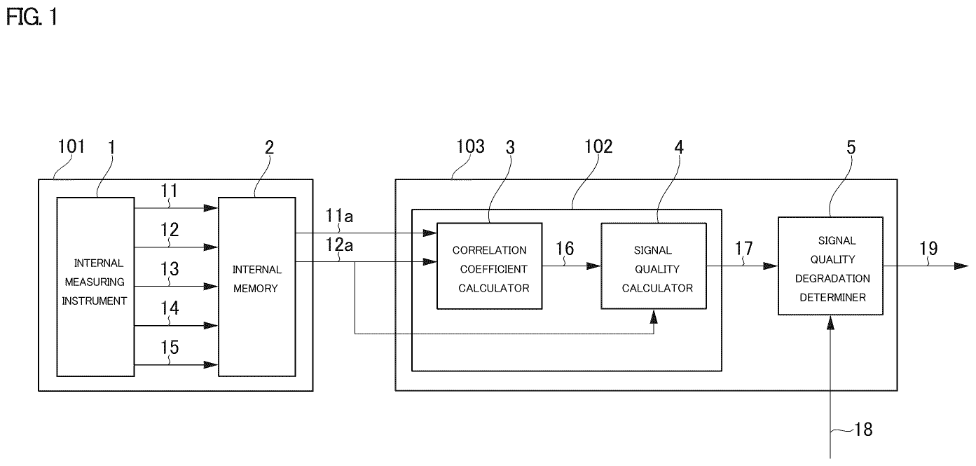

Hereinafter, preventive maintenance means for an optical module according to a first embodiment of the present invention will be explained with reference to FIGS. 1 through 4.

FIG. 1 is a configuration diagram of the preventive maintenance means for an optical module according to the first embodiment.

The preventive maintenance means for an optical module according to the present embodiment includes an optical module 101 and an information apparatus 103 that is connected to the optical module 101.

The information apparatus 103 is an information apparatus to which the optical module 101 is connected. For example, the information apparatus 103 is a storage apparatus or a network switch for use in a data center.

With regard to a large number of storage apparatuses that are used in the data center, connection between the storage apparatuses and connection between a storage apparatus and a network switch are established usually via multimode fiber (MMF). Moreover, connection between a storage apparatus or a network switch and MMF is established via the optical module 101.

The optical module 101 includes an internal measuring instrument 1 and an internal memory 2.

By means of the internal measuring instrument 1, the optical module 101 measures a bias current 11, optical transmission power 12, optical reception power 13, a module environment temperature 14, and a module power source voltage 15, and saves the measurement results in the internal memory 2.

The information apparatus 103 includes a signal quality converter 102 and a signal quality degradation determiner 5.

Further, the signal quality converter 102 includes a correlation coefficient calculator 3 and a signal quality calculator 4.

Operation of the information apparatus 103 is as follows.

First, the information apparatus 103 reads out a bias current measurement value 11a and an optical transmission power measurement value 12a saved in the internal memory 2.

Further, the correlation coefficient calculator 3 of the signal quality converter 102 uses the read bias current measurement value 11a and the read optical transmission power measurement value 12a to calculate a correlation coefficient 16 for converting an optical transmission power to a signal quality.

Subsequently, the signal quality calculator 4 calculates a signal quality 17 from the correlation coefficient 16 and the optical transmission power measurement value 12a.

Next, the signal quality degradation determiner 5 compares the signal quality 17 with a preset signal quality degradation identification value 18. If the signal quality 17 is poorer than the signal quality degradation identification value 18, the signal quality degradation determiner 5 gives a report on light emitting element degradation information 19.

It is to be noted that the internal measuring instrument 1 and the internal memory 2 of the optical module 101 may be substituted by a digital diagnostic monitoring (DDM) function which is supported as a general standard optical module function.

The bias current measurement value 11a and the optical transmission power measurement value 12a may be measured with such measuring instruments as a current meter and an optical power meter.

The signal quality 17 may be transmitter and dispersion penalty eye closure for PAM4 (TDECQ) instead of a BER.

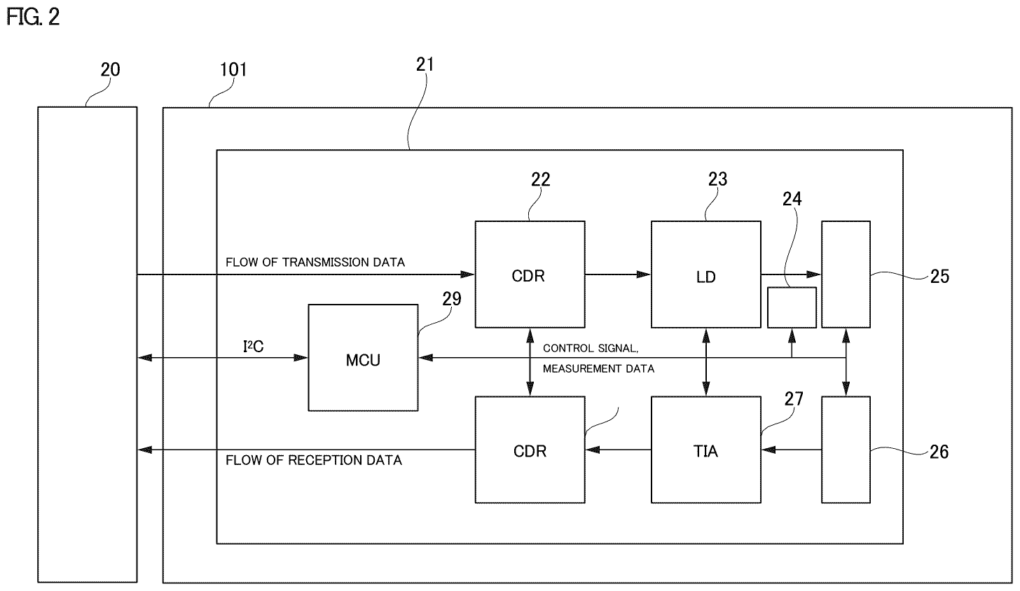

FIG. 2 is a schematic configuration diagram (block diagram) of the optical module 101 in FIG. 1 according to the first embodiment. It is to be noted that the block diagram in FIG. 2 depicts a general configuration of the optical module, which is applicable to both an optical module adopting the abovementioned DDM function and an optical module that does not adopt the DDM function.

FIG. 2 depicts the optical module 101 and a connection apparatus 20 connected to the optical module 101. Examples of the connection apparatus 20 include the information apparatus 103 (e.g. a storage apparatus or a network switch) depicted in FIG. 1.

As depicted in FIG. 2, a clock and data recovery (CDR) circuit 22, a laser driver (LD) 23, a temperature sensor 24, a transmitter optical sub-assembly (TOSA) 25, a receiver optical sub-assembly (ROSA) 26, a trance impedance amplifier (TIA) 27, a CDR circuit 28, and a micro controller unit (MCU) 29 are disposed on a printed circuit board 21 in a housing (casing) of the optical module 101.

The CDR circuits 22 and 28 receive a signal in which a clock is superimposed on data on a transmission line, and separate the clock and the data from each other.

The LD circuit 23 oscillates a light emitting element such as a laser.

The temperature sensor 24 detects an ambient temperature.

The TOSA 25 includes, as a light emitting element, a laser such as a vertical cavity surface emitting laser (VCSEL).

The ROSA 26 includes a light reception element such as a photodiode.

The TIA 27 is an amplifier for converting an input current to a resistance (impedance)-fold voltage, and includes an equalizer function.

The MCU 29 controls the CDR 22, the LD 23, the temperature sensor 24, the TOSA 25, the ROSA 26, the TIA 27, and the CDR 28.

The MCU 29 exchanges signals with the connection apparatus 20 through inter-integrated circuit (I²C) communication.

A flow of transmission data from the connection apparatus 20 is from the connection apparatus 20 to the CDR 22, the LD 23, and the TOSA 25.

A flow of reception data to the connection apparatus 20 is from the ROSA 26 to the TIA 27, the CDR 28, and the connection apparatus 20.

As a result of this exchange of data and a control signal, the optical module 101 can store the measurement values 11 through 15 in the internal memory 2, as depicted in FIG. 1.

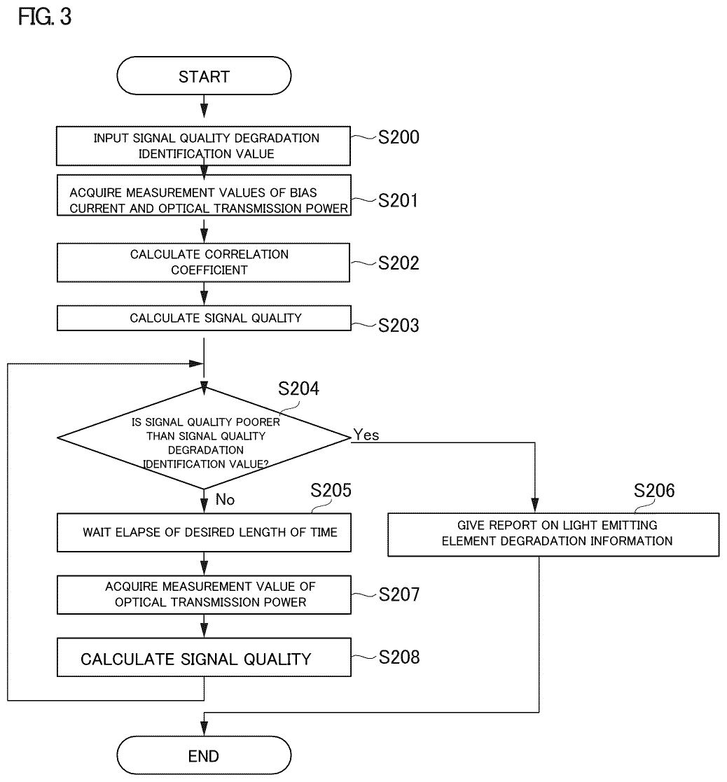

FIG. 3 is a flowchart of the preventive maintenance means for an optical module according to the first embodiment.

In the present embodiment, first, a user defines a desired signal quality degradation identification value 18, and inputs the defined signal quality degradation identification value 18 (step S200), as depicted in FIG. 3.

Next, the information apparatus 103 acquires the bias current measurement value 11a and the optical transmission power measurement value 12a from the internal memory 2 of the optical module 101 (step S201).

Subsequently, the correlation coefficient calculator 3 of the signal quality converter 102 of the information apparatus 103 calculates the correlation coefficient 16 from the bias current measurement value 11a and the optical transmission power measurement value 12a (step S202).

Then, the signal quality calculator 4 calculates the signal quality 17 from the optical transmission power measurement value 12a and the correlation coefficient 16 (step S203).

Next, the signal quality degradation determiner 5 determines whether the signal quality 17 is poorer than the signal quality degradation identification value 18 by comparing the signal quality 17 and the signal quality degradation identification value 18 (step S204).

If “No” (not poorer) is determined in step S204, elapse of an appropriate length of time is waited (step S205), and the signal quality converter 102 acquires the updated optical transmission power measurement value 12a (step S207).

Then, the signal quality calculator 4 calculates the signal quality 17 from the correlation coefficient 16 calculated in step S202 and the updated optical transmission power measurement value 12a (step S208).

Thereafter, step S204 is executed again.

If “Yes” (poorer) is determined in step S204, the signal quality degradation determiner 5 gives a report on the light emitting element degradation information 19 (step S206).

Here, the function of the signal quality converter 102 will be explained in detail.

First, the signal quality converter 102 defines a correlation expression for converting the optical transmission power measurement value 12a to the signal quality 17. The correlation expression is expression (1.1) below.

$$\begin{matrix}[ Expression 1 ] & \\ TDECQ = A \cdot {{P}_{Tx}}^{B} + 1 & ( 1.1 )\end{matrix}$$

In expression (1.1), TDECQ represents the signal quality 17, P_{Tx} represents the optical transmission power measurement value 12a, and A and B respectively represent a first feature amount and a second feature amount that are obtained from the bias current measurement value 11a and the optical transmission power measurement value 12a.

A which represents the first feature amount is calculated as the value of A when the ratio of optical transmission power and a bias current has a particular value in accordance with the relation of A with respect to the ratio. B which represents the second feature amount is calculated as the value of B when the ratio of optical transmission power and a bias current has a particular value in accordance with the relation of B with respect to the ratio.

On the basis of a value obtained by dividing the optical transmission power measurement value 12a by the bias current measurement value 11a (I-L slope S_{I-L}) which is determined for each optical module 101, the first feature amount A and the second feature amount B can be defined in accordance with expressions (2) and (3) below.

$$A = α1 \times {{S}_{I - L}}^{β1} \qquad ( 2 )$$

$$B = α2 \times {{S}_{I - L}}^{β2} \qquad ( 3 )$$

In the above expressions, α1, β1, α2, and β2 are fitting parameters, and have respective domains of α1>0, β1<0, α2<0, and β2<0. The values of the fitting parameters α1, β1, α2, and β2 can be defined, as appropriate, within the respective domains according to characteristics of the optical module 101.

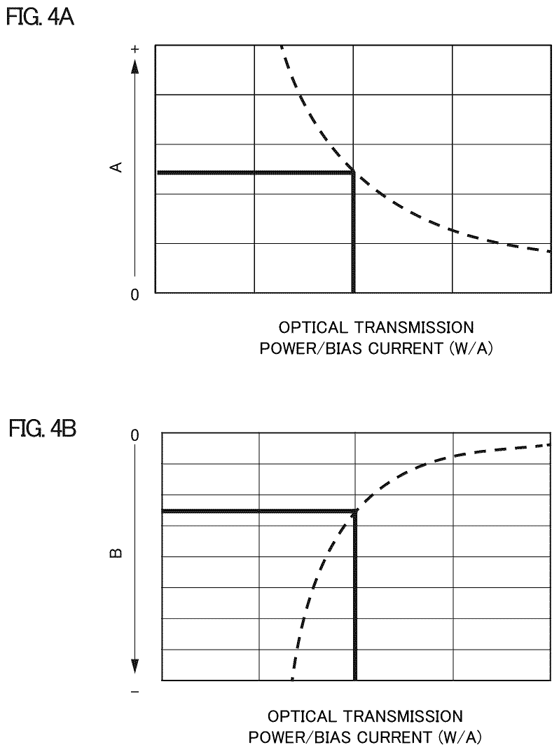

FIGS. 4A and 4B are diagrams each depicting a method for calculating a correlation coefficient at the signal quality converter 102 in FIG. 1. FIGS. 4A and 4B depict the first feature amount A and the second feature amount B, respectively.

In each of FIGS. 4A and 4B, the horizontal axis indicates the abovementioned I-L slope (a value obtained by dividing the optical transmission power measurement value 12a by the bias current measurement value 11a). In each of FIGS. 4A and 4B, the vertical axis indicates the first feature amount A or the second feature amount B.

A broken line in FIGS. 4A and 4B indicates a correlation characteristic between the first feature amount A or the second feature amount B and the I-L slope based on expressions (2) and (3).

As depicted in a solid line in FIGS. 4A and 4B, the value of the I-L slope reaches a particular value according to the state of the optical module 101, and the value of each of the first feature amount A and the second feature amount B is determined on the basis of the correlation characteristics between the particular value of the I-L slope and the broken line.

Further, TDECQ of the signal quality 17 is determined according to the determined first feature amount A and second feature amount B and the optical transmission power measurement value 12a.

It is to be noted that, since TDECQ can be converted to a BER, as indicated by the following expression (1.2), the signal quality 17 can be substituted by a BER.

$$\begin{matrix}[ Expression 2 ] & \\ BER = \frac{3}{8} erfc ( \frac{{Q}_{T}}{\sqrt{2}} \sqrt{\frac{{TDECQ}^{2}}{{TDECQ}^{2} - 1}} ) & ( 1.2 )\end{matrix}$$

In expression (1.2), erfc represents a complementary error function, and Q_{T} represents an eigenvalue, or is 3.414 in 50 Gigabit Ethernet (Ethernet: registered trademark), for example.

As explained so far, with the preventive maintenance means for an optical module according to the present embodiment, a BER can be estimated with high accuracy according to the degradation state of the optical module, and replacement of the optical module at a proper timing can be promoted.

### Second Embodiment

Hereinafter, preventive maintenance means for an optical module according to a second embodiment of the present invention will be explained.

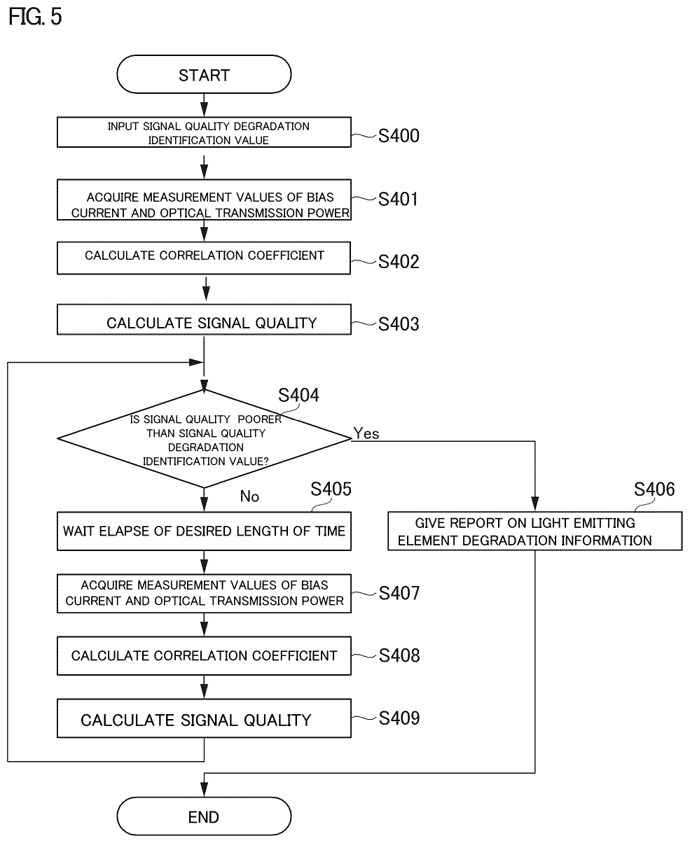

FIG. 5 is a flowchart of the preventive maintenance means for an optical module according to the second embodiment of the present invention.

The preventive maintenance means for an optical module according to the present embodiment is different from that of the first embodiment in that the correlation coefficient calculator 3 of the signal quality converter 102 of the information apparatus 103 calculates the correlation coefficient 16 each time a desired length of time elapses.

In the present embodiment, first, a user defines a desired signal quality degradation identification value 18, and inputs the defined signal quality degradation identification value 18 (step S400), as depicted in FIG. 5.

Next, the information apparatus 103 acquires the bias current measurement value 11a and the optical transmission power measurement value 12a from the internal memory 2 of the optical module 101 (step S401).

Subsequently, the correlation coefficient calculator 3 of the signal quality converter 102 of the information apparatus 103 calculates the correlation coefficient 16 from the bias current measurement value 11a and the optical transmission power measurement value 12a (step S402).

Then, the signal quality calculator 4 calculates the signal quality 17 from the optical transmission power measurement value 12a and the correlation coefficient 16 (step S403).

Next, the signal quality degradation determiner 5 determines whether the signal quality 17 is poorer than the signal quality degradation identification value 18 by comparing the signal quality 17 and the signal quality degradation identification value 18 (step S404).

If “No” (not poorer) is determined in step S404, elapse of a desired length of time is waited (step S405), and the signal quality converter 102 acquires the updated bias current measurement value 11a and the updated optical transmission power measurement value 12a (step S407).

Subsequently, the correlation coefficient calculator 3 calculates the correlation coefficient 16 from the updated bias current measurement value 11a and the updated optical transmission power measurement value 12a (step S408).

Next, the signal quality calculator 4 calculates the signal quality 17 from the updated optical transmission power measurement value 12a and the correlation coefficient 16 (step S409).

Thereafter, step S404 is executed again.

If “Yes” (poorer) is determined in step S404, the signal quality degradation determiner 5 gives a report on the light emitting element degradation information 19 (step S406).

As explained so far, according to the preventive maintenance means for an optical module according to the present embodiment, a BER can be estimated with high accuracy according to the degradation state of the optical module, and replacement of the optical module at a proper timing can be promoted.

It is to be noted that the present invention is not limited to the abovementioned embodiments, and encompasses various modifications. For example, the abovementioned embodiments have been described in detail for better understanding of the present invention, and hence, the present invention is not necessarily limited to an embodiment that includes all the features described above.

Moreover, part of a configuration example of one of the embodiments can be replaced with another configuration example of the same embodiment or a configuration example of another embodiment. In addition, to a configuration example of one of the embodiments, another configuration example of the same embodiment or a configuration example of another embodiment can be added. Further, in each of the embodiments, addition, deletion, or replacement of part of a configuration may be made with part of another configuration.

Furthermore, the abovementioned configurations, functions, processing units, processing means, etc., may be implemented by hardware by, for example, designing part or all thereof on an integrated circuit. In addition, the abovementioned configurations, functions, etc., may be implemented by software by, for example, interpreting and executing programs to cause a processor to implement respective functions. Information in the programs for implementing the respective functions, a table, a file, etc., can be stored in a recording device such as a memory, a hard disk, or a solid state drive (SSD), or in a recording medium such as an integrated circuit (IC) card, a secure digital (SD) card, or a digital versatile disc (DVD).

In addition, a control line and an information line that are considered to be necessary in the explanation have been illustrated; not all control lines or information lines required for products have been illustrated. It can be considered that, in practice, almost all the structures are mutually connected.

What is claimed is:

1. A preventive maintenance method for an optical module, for preventing degradation of an optical module and performing maintenance of the optical module, the optical module including an internal measuring instrument that measures physical quantities including optical transmission power and a bias current and an internal memory in which the measured physical quantities are recorded, the method comprising:
reporting a degradation state of a light emitting element of the optical module by a control unit using a diagnosis result obtained by a signal quality degradation determiner, the control unit including a correlation coefficient calculator that calculates, from the optical transmission power and the bias current recorded in the internal memory of the optical module, a correlation coefficient for converting the optical transmission power to a signal quality, a signal quality calculator that calculates a signal quality with use of a correlation expression including the optical transmission power and the correlation coefficient, and the signal quality degradation determiner that diagnoses degradation in the signal quality by comparing the signal quality and a signal quality degradation identification value.

2. The preventive maintenance method for an optical module according to claim 1, wherein
the correlation coefficient calculator calculates the correlation coefficient in accordance with a correlation expression (1.1):
$$TDECQ = A \cdot {{P}_{Tx}}^{B} \qquad ( 1.1 )$$
[in expression (1.1), TDECQ represents the signal quality, P_{Tx} represents a measurement value of the optical transmission power, and A and B respectively represent a first feature amount and a second feature amount that are obtained from a measurement value of the bias current and a measurement value of the optical transmission power].

3. The preventive maintenance method for an optical module according to claim 2, wherein
the A which represents the first feature amount is calculated as a value of the A when a ratio of the optical transmission power and the bias current has a particular value in accordance with a relation of the A with respect to the ratio, and the B which represents the second feature amount is calculated as a value of the B when a ratio of the optical transmission power and the bias current has a particular value in accordance with a relation of the B with respect to the ratio.

4. The preventive maintenance method for an optical module according to claim 3, wherein
the relation of the A with respect to the ratio of the optical transmission power and the bias current is expressed by expression (2), and the relation of the B with respect to the ratio of the optical transmission power and the bias current is expressed by expression (3):
$$A = α1 \times {{S}_{I - L}}^{β1} \qquad ( 2 )$$
$$B = α2 \times {{S}_{I - L}}^{β2} \qquad ( 3 )$$
[in expressions (2) and (3), α1, β1, α2, and β2 are fitting parameters, and have respective domains of α1>0, β1<0, α2<0, and β2<0].

5. The preventive maintenance method for an optical module according to claim 1, wherein,
in the correlation coefficient calculator, the correlation coefficient is updated each time a desired length of time elapses.

6. A preventive maintenance apparatus for an optical module, for preventing degradation of an optical module and performing maintenance of the optical module, the preventive maintenance apparatus being targeted for an optical module including an internal measuring instrument that measures physical quantities including optical transmission power and a bias current and an internal memory in which the measured physical quantities are recorded, the preventive maintenance apparatus comprising:
a correlation coefficient calculator that calculates, from the optical transmission power and the bias current recorded in the internal memory of the optical module, a correlation coefficient for converting the optical transmission power to a signal quality;
a signal quality calculator that calculates a signal quality with use of a correlation expression including the optical transmission power and the correlation coefficient; and
a signal quality degradation determiner that diagnoses degradation in the signal quality by comparing the signal quality and a signal quality degradation identification value,
the preventive maintenance apparatus being configured to report a degradation state of a light emitting element of the optical module with use of a diagnosis result obtained by the signal quality degradation determiner.

7. The preventive maintenance apparatus for an optical module according to claim 6, wherein,
in the correlation coefficient calculator, the correlation coefficient is updated each time a desired length of time elapses.
